(19) United States
(12) Patent Application Publication
(10) Pub. No.: US 2009/0318077 A1
(43) Pub. Date: Dec. 24, 2009

(54) Television Audio via Phone

(75) Inventor: Fred Ghahramani, San Jose, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,898

(22) Filed: Jun. 18, 2008

(51) Int. Cl. H04H 40/00; H04N 7/173; H04M 1/00

(52) U.S. Cl. 455/3.06; 725/106; 455/556.1

(57) ABSTRACT

Television audio via phone is described. In embodiment(s), a request for a television program or television channel can be received from a mobile phone, such as via a mobile communications network. A video feed of the television program or channel can be accessed to obtain television audio that corresponds to the television program or channel, and the television audio can then be communicated to the mobile phone to render as a telephone communication.

### BACKGROUND

Viewers have an ever-increasing selection of media content to choose from, such as television programming, movies, videos, and music that is available for streaming from a content distributor to a media device. For example, some mobile phones and other portable data and computing devices can be connected for Internet access to download the various types of media content for viewing. However, it is not always practical or safe for a user of a mobile phone or other portable data device to view television programming, such as when driving or when a user does not have a device that displays video media content.

### SUMMARY

This summary is provided to introduce simplified concepts of television audio via phone. The simplified concepts are further described below in the Detailed Description. This summary is not intended to identify essential features of the claimed subject matter, nor is it intended for use in determining the scope of the claimed subject matter.

Television audio via phone is described. In embodiment(s), a request for a television program can be received from a mobile phone, such as via a mobile communications network. A video feed of the television program can be accessed to obtain television audio that corresponds to the television program, and the television audio can then be communicated to the mobile phone to render as a telephone communication. In other embodiment(s), a request for a television channel can be received from a mobile phone, such as via a mobile communications network. A video feed of the television channel can be accessed to obtain television audio that corresponds to the television channel, and the television audio can then be communicated to the mobile phone to render as a telephone communication.

In other embodiment(s), a request for a television program or channel can be received as a telephone call that is initiated from a mobile phone, or can be received as a text message that is initiated from the mobile phone. A telephone call from a mobile phone can include menu selections, such as keypad inputs and/or voice-prompted inputs, to identify the television program or channel that is requested. A text message from a mobile phone can be parsed to determine the television program or channel that is requested, and a telephone call can then be initiated back to the mobile phone to communicate the television audio that corresponds to the television program or channel to the mobile phone.

### BRIEF DESCRIPTION OF THE DRAWINGS

Embodiments of television audio via phone are described with reference to the following drawings. The same numbers are used throughout the drawings to reference like features and components:

FIG. 1 illustrates an example system in which embodiments of television audio via phone can be implemented.

FIG. 2 illustrates another example system in which embodiments of television audio via phone can be implemented.

FIG. 3 illustrates example method(s) for television audio via phone in accordance with one or more embodiments.

FIG. 4 illustrates example method(s) for television audio via phone in accordance with one or more embodiments.

FIG. 5 illustrates various components of an example service that can implement embodiments of television audio via phone.

FIG. 6 illustrates various components of an example device that can implement embodiments of television audio via phone.

### DETAILED DESCRIPTION

Embodiments of television audio via phone provide that a user can initiate a request for a television program, or television channel, from a mobile phone, and receive the audio that corresponds to the television program or channel as a telephone communication. For example, a user of a mobile phone may be driving or stuck in traffic and cannot get home in time to watch the evening news, or some other television program that is of interest to the user. The user can initiate a request for the evening news from a mobile phone, and receive as a telephone communication (e.g., a telephone call), the television audio for the evening news. Additionally, the user can listen to the television audio via a car audio system if the mobile phone is integrated with the car audio system.

In another example, a user of a mobile phone can initiate a request to hear a program listing, such as a program listing of the television programs that are scheduled for viewing when the user gets home. The user of the mobile phone can also initiate a request to hear the television audio that corresponds to the television program which is currently being rendered at a television client device, such as in the user's home. As a parent, the user can check-up on what the kids are currently watching before the user is able to get home.

In one or more embodiments, a request for the television audio that corresponds to a particular television program or television channel can be initiated as a telephone call from the mobile phone, or initiated as a text message from the mobile phone. A telephone call to initiate a request for a television program or television channel can include menu selections, such as keypad inputs and/or voice-prompted inputs, to identify the television program or channel that is being requested. A text message to initiate a request for a television program or television channel can be parsed to determine the television program or channel that is requested, and a telephone call can then be initiated back to the mobile phone to communicate the television audio that corresponds to the television program or channel to the mobile phone.

While features and concepts of the described systems and methods for television audio via phone can be implemented in any number of different environments, systems, and/or various configurations, embodiments of television audio via phone are described in the context of the following example systems and environments.

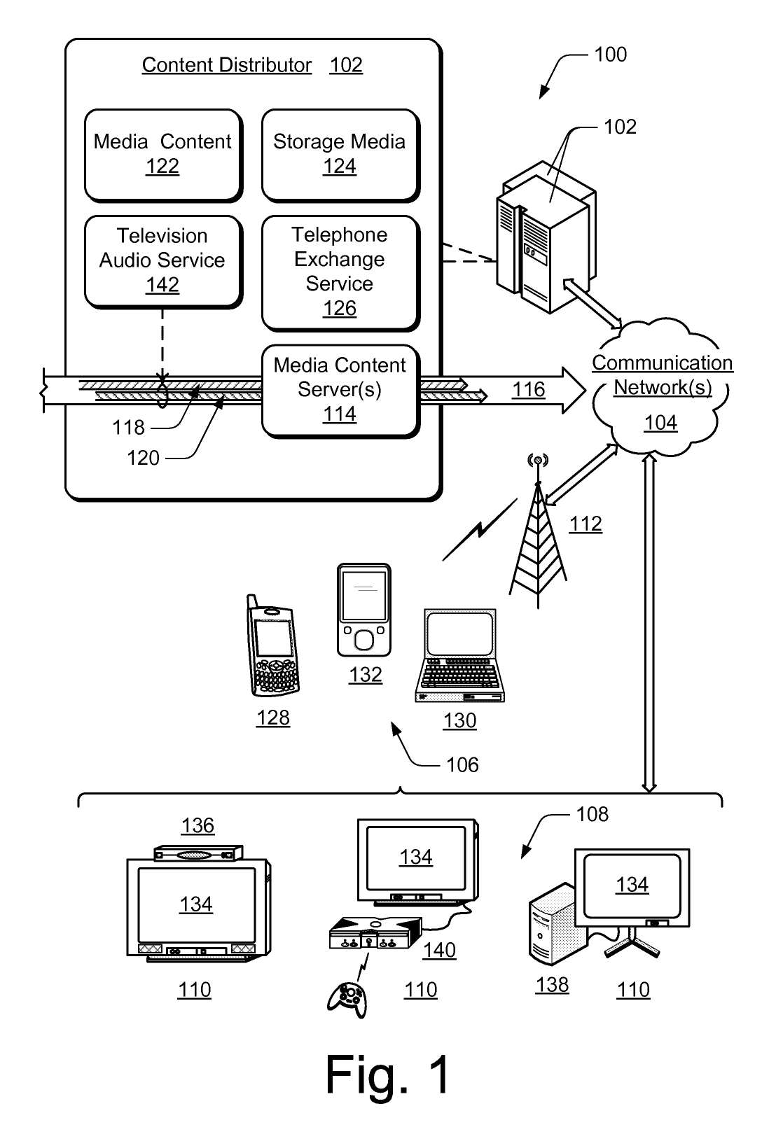

FIG. 1 illustrates an example system 100 in which various embodiments of television audio via phone can be implemented. In this example, system 100 includes one or more content distributors 102 that communicate or otherwise provide media content to any number of various media devices via communication network(s) 104. The various media devices can include wireless media devices 106 as well as other media devices 108 (e.g., wired and/or wireless client devices) that are implemented as components in various client systems 110. In a media content distribution system, the content distributors 102 facilitate the distribution of media content, content metadata, and/or other associated data to multiple viewers, users, customers, viewing systems, and devices.

The communication network(s) 104 can be implemented to include any type of data network, voice network, broadcast network, an IP-based network, a wide area network (e.g., the Internet), and/or a wireless network 112 that facilitates media content distribution, as well as data and/or voice communications between the content distributors 102 and any number of the various media devices. The communication network(s) 104 can also be implemented using any type of network topology and/or communication protocol, and can be represented or otherwise implemented as a combination of two or more networks. Any one or more of the arrowed communication links facilitate two-way communications, such as from the content distributor 102 to a media device 108 (e.g., a client device) and vice-versa.

The content distributor 102 can include media content servers 114 that are implemented to receive video feed(s) 116 of television media content for distribution to subscriber media devices. The content distributor 102 can receive video feed 116 of television media content 118 and corresponding television audio 120 from various content sources, such as a content provider, an advertiser, a national television distributor, and the like. The content distributor 102 can communicate or otherwise distribute media content 122 (e.g., to include the television media content 118 and the corresponding television audio 120) and/or other data to any number of the various wireless media devices 106 and other media devices 108.

The media content 122 (e.g., to include recorded media content) can include any type of audio, video, and/or image media content received from any type of media content source. As described throughout, “media content” can include television programs (or programming), advertisements, commercials, music, movies, and on-demand media content. Other media content can include interactive games, network-based applications, and any other audio, video, and/or image content (e.g., to include program guide application data, user interface data, advertising content, closed captions data, content metadata, search results and/or recommendations, and the like).

In the example system 100, the content distributor 102 includes storage media 124 to store or otherwise maintain various data and media content, such as media content 122 and media content metadata. In a Network Digital Video Recording (nDVR) implementation, recorded on-demand assets can be recorded when initially distributed to the various media devices as scheduled television media content, and stored with the storage media 124 or other suitable storage device. The storage media 124 can be implemented as any type of memory, random access memory (RAM), read only memory (ROM), any type of magnetic or optical disk storage, and/or other suitable electronic data storage.

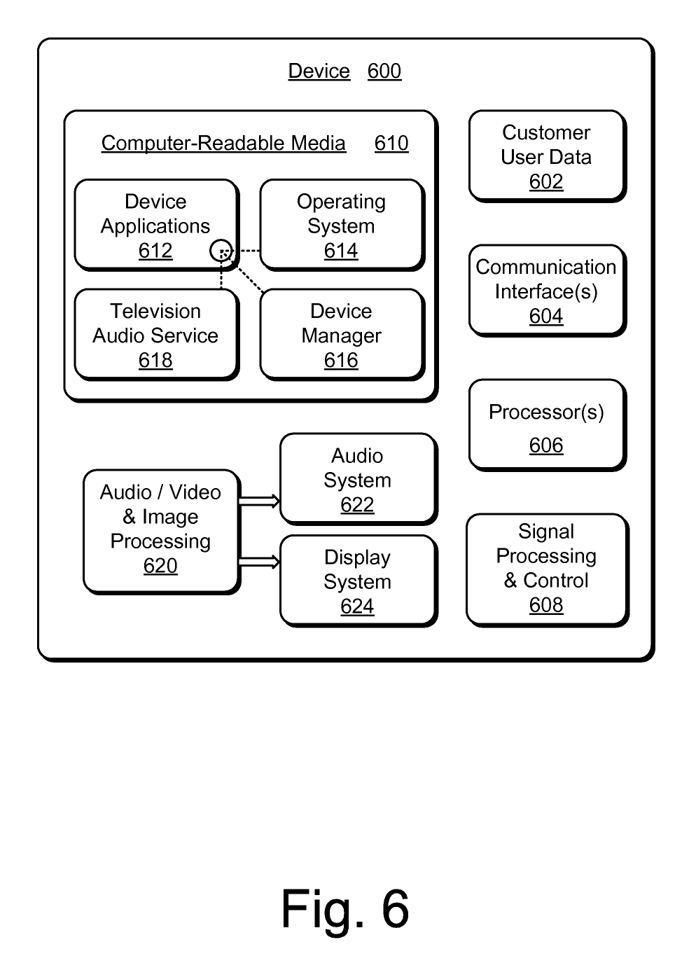

In this example, content distributor 102 includes a telephone exchange service 126 that can be implemented to receive telephone communications, such as telephone calls and/or text messages from a mobile phone. In addition, a content distributor 102 can be implemented with any number and combination of differing components as further described with reference to the example device shown in FIG. 6. Although illustrated and described as a component or module of the content distributor 102, the telephone exchange service 126, as well as other functionality described to implement embodiments of television audio via phone, can also be provided as a service apart from the content distributor 102 (e.g., on a separate server or by a third party service).

The wireless media devices 106 can include any type of device implemented to receive and/or communicate wireless data and voice communications, such as any one or combination of a mobile phone 128 (e.g., cellular, VoIP, WiFi, etc.), a portable computer device 130, a media device 132 (e.g., a personal media player, portable media player, etc.), and/or any other wireless media device that can receive media content in any form of audio, video, and/or image data. Each of the client systems 110 include a respective client device and display device 134 that together render or playback any form of audio, video, and/or image content, media content, and/or television content.

A display device 134 can be implemented as any type of a television, high definition television (HDTV), LCD, or similar display system. A client device in a client system 110 can be implemented as any one or combination of a television client device 136 (e.g., a television set-top box, a digital video recorder (DVR), etc.), a computer device 138, a gaming system 140, an appliance device, an electronic device, and/or as any other type of client device that can be implemented to receive television content or media content in any form of audio, video, and/or image data in a media content distribution system.

Any of the wireless media devices 106 and/or other media devices 108 can be implemented with one or more processors, communication components, memory components, signal processing and control circuits, and a media content rendering system. A media device may also be associated with a user or viewer (i.e., a person) and/or an entity that operates the device such that a media or client device describes logical devices that include users, software, and/or a combination of devices.

In this example, the content distributor 102 includes a television audio service 142 that can be implemented as computer-executable instructions and executed by processor(s) to implement various embodiments and/or features of television audio via phone. Although illustrated and described as a component or module of the content distributor 102, the television audio service 142, as well as other functionality described to implement embodiments of television audio via phone, can also be provided as a service apart from the content distributor 102 (e.g., on a separate server or by a third party service).

In one or more embodiments of television audio via phone, a user of mobile phone 128 can initiate a request for a television program or television channel from the mobile phone, such as when driving or stuck in traffic. The telephone exchange service 126 can receive the request for the television program or channel as a telephone call initiated from the mobile phone, or as a text message initiated from the mobile phone. In an embodiment, a telephone call to request the television program or channel can include various menu selections, such as keypad inputs and/or voice-prompted inputs, that identify the requested television program or channel.

The telephone exchange service 126 can interface with the television audio service 142 that can be implemented to receive the request for the television program and obtain the television audio that corresponds to the requested television program or channel. In an embodiment, the television audio service 142 can parse a text message to determine the requested television program or channel when the request is received as a formatted text message. The television audio service 142 can obtain the television audio that corresponds to the television program or channel by accessing the video feed 116 of the television media content 118 to obtain the corresponding television audio 120. Alternatively, the television audio service 142 can communicate with the media content server(s) 114, or another component of the content distributor 102, to obtain the television audio that corresponds to a requested television program or channel.

In an embodiment, the television audio service 142 can also determine that the mobile phone 128 is registered to a user that has a corresponding television client device 136 as a customer of the media content distribution system. For example, the content distributor 102 can include a feature for authentication to verify that a particular mobile phone is associated with a customer account. A unique identifier can be established for a particular user, mobile phone, and/or client device where the unique identifier is some combination of a user identifier, a client device identifier, a mobile phone identifier, a phone number, and any other identifier that can be utilized for customer registration and/or authentication.

When the television audio service 142 obtains the television audio 120, the telephone exchange service 126 can initiate communication of the television audio to the mobile phone 128 that can render the television audio as a telephone communication (e.g., a telephone call). In an event that a request for a television program or channel is received as a text message, the telephone exchange service 126 can initiate a telephone call to the mobile phone 128 to establish a communication link by which the television audio that corresponds to the television program or channel is communicated to the mobile phone. The user of the mobile phone 128 that may be driving or stuck in traffic can then receive, as a telephone call, the television audio of a television program, such as the evening news, a talk show, a sporting event, or any other type of television program or audio feed that is associated with a particular television channel.

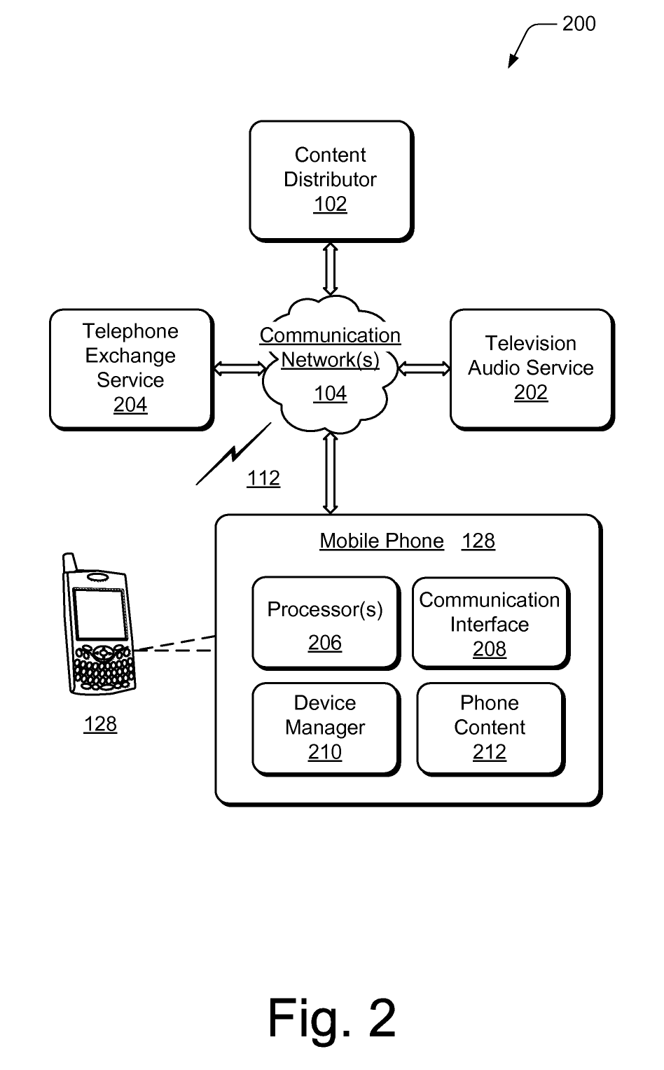

FIG. 2 illustrates an example system 200 in which various embodiments of television audio via phone can be implemented. In this example, system 200 includes the content distributor 102 and mobile phone 128 as described with reference to FIG. 1. System 200 also includes an example of a television audio service 202 and a telephone exchange service 204. The content distributor 102, television audio service 202, telephone exchange service 204, and mobile phones (e.g., mobile phone 128) can all be implemented for communication with each other via the communication network(s) 104 and/or the wireless network 112.

In this example, the television audio service 202 and the telephone exchange service 204 are each implemented as independent components of system 200, and can each implement the functions described with reference to FIG. 1. In addition, the telephone exchange service 204 can provide for mobile data and/or voice communications. For example, the telephone exchange service 204 may be implemented as a communication service provider, a cell-phone provider, an Internet service provider, and/or a combination thereof. The telephone exchange service 204 enables data and/or voice communications for any type of a mobile device or mobile phone 128 (e.g., cellular, VoIP, WiFi, etc.), and/or any other wireless media or communication device that can receive data, voice, or media content in any form of audio, video, and/or image data.

The television audio service 202 can be implemented as a subscription-based service to provide television audio via a phone. The television audio service 202 can also be implemented as an independent or third-party service to implement the various embodiments of television audio via phone as described herein. Alternatively, the television audio service 202 can be implemented as a component or service of the content distributor 102, and optionally, made available as a service or feature of a cell phone connection plan.

The mobile phone 128 can be implemented with processing, communication, and memory components, as well as signal processing and control circuits. The mobile phone 128 device may also be associated with a user or owner (i.e., a person) and/or an entity that operates the device such that a mobile phone describes logical devices that include users, software, and/or a combination of devices. In this example, the mobile phone 128 includes one or more processors 206 (e.g., any of microprocessors, controllers, and the like), a communication interface 208 to receive and/or communicate data and voice communications, and a device manager 210 (e.g., a control application, software application, signal processing and control module, etc.).

The mobile phone 128 also includes phone content 212, such as configuration settings of the mobile phone, media content received and/or stored on the mobile phone, information associated with a user of the mobile phone (e.g., user profile data and/or registration data that can be communicated to the content distributor 102), and/or messaging content that has been received and/or communicated via the mobile phone. The device manager 210 can include communication logic to communicate registration and/or authentication information (e.g., phone content 212) to indicate that the mobile phone 128 is registered to a user that has a corresponding television client device as a customer of a media content distribution system.

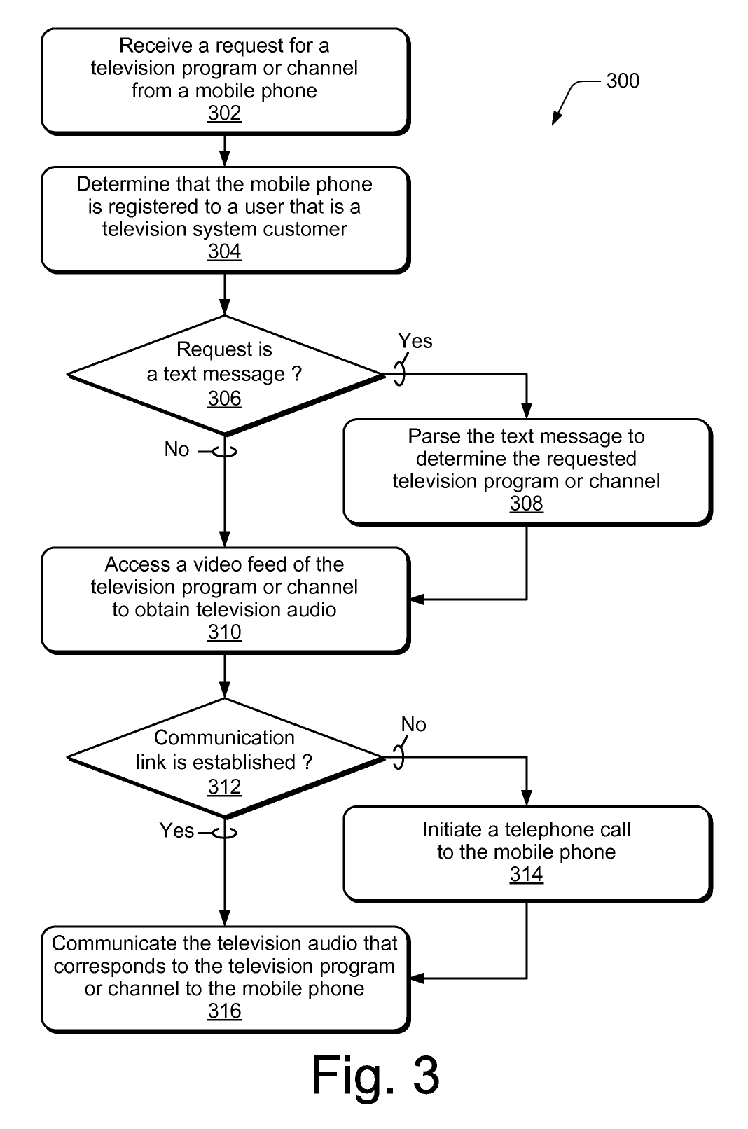

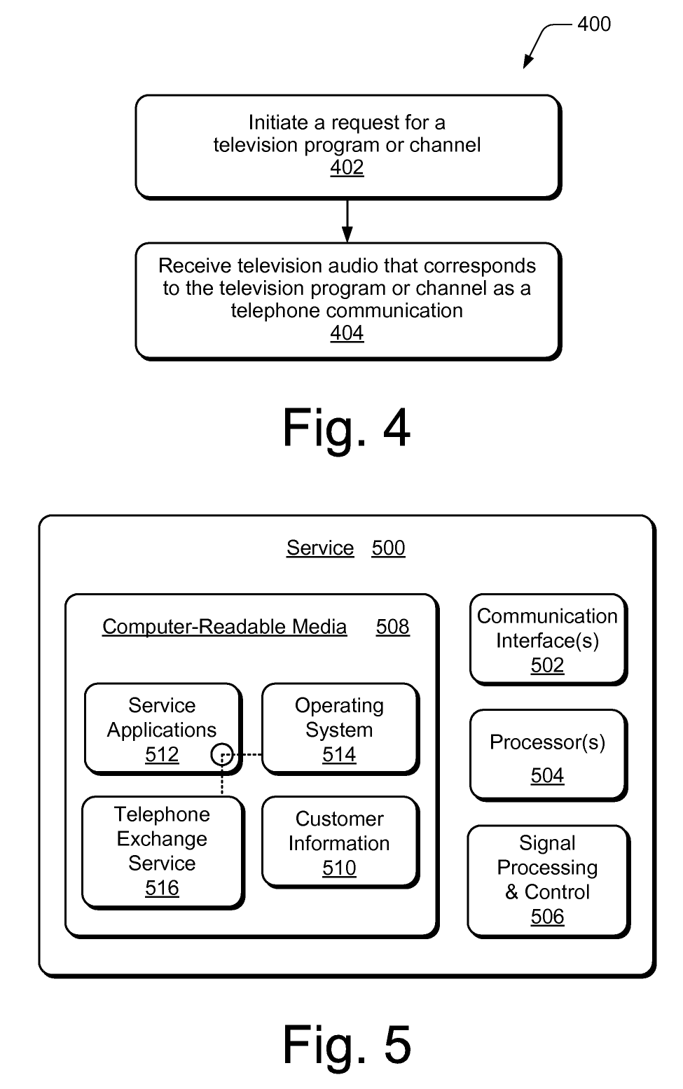

Example methods 300 and 400 are described with reference to respective FIGS. 3 and 4 in accordance with one or more embodiments of television audio via phone. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example methods 300 and 400 may be described in the general context of computer-executable instructions. Generally, computer-executable instructions can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of television audio via phone, and is described with reference to a television audio service. The order in which the method is described is not intended to be construed as a limitation, and any number of the described method blocks can be combined in any order to implement the method, or an alternate method.

At block 302, a request for a television program or channel is received from a mobile phone. For example, telephone exchange service 126 at content distributor 102 (FIG. 1) receives a request for a television program or channel as a telephone call initiated from mobile phone 128. The telephone call can include menu selections, such as keypad inputs or voice-prompted inputs, to identify the television program or television channel that is being requested. In another example, the telephone exchange service 126 receives a request for a television program or channel as a text message that is initiated from the mobile phone 128.

At block 304, the mobile phone is determined to be registered to a user that is a television system customer. For example, the television audio service 142 at content distributor 102 determines that the mobile phone 128 is registered to a user that has a corresponding television client device 136 as a customer of a media content distribution system.

At block 306, a determination is made as to whether the request for the television program or channel is received as a text message. If the request for the television program or channel is received as a text message (i.e., “yes” from block 306), then at block 308, the text message is parsed to determine the television program or channel that is being requested. For example, the television audio service 142 parses the text message to determine the requested television program or channel when the request is received as a formatted text message.

If the request for the television program or channel is received as a telephone call (i.e., “no” from block 306), or continuing from block 308, a video feed of the television program or channel is accessed to obtain television audio that corresponds to the television program or channel at block 310. For example, the television audio service 142 accesses video feed 116 of television media content 118 to obtain the corresponding television audio 120. Alternatively, the television audio service 142 can communicate with the media content server(s) 114, or another component of the content distributor 102, to obtain the television audio that corresponds to a requested television program or channel.

At block 312, a determination is made as to whether a communication link is established with the mobile phone. For example, if a request for a television program or channel is received as a telephone call initiated from mobile phone 128, then a communication link (e.g., telephone call) is already established between the telephone exchange service 126 and mobile phone 128. However, if a request for a television program or channel is received as a text message, then a communication link likely has not been maintained (e.g., other than to receive the text message).

If a communication link with the mobile phone is not established (i.e., “no” from block 312), then at block 314, a telephone call is initiated to the mobile phone. For example, the telephone exchange service 126 initiates a communication link (e.g., telephone call) to the mobile phone 128. If a communication link with the mobile phone is established (i. e., “yes” from block 312), or continuing from block 314, the television audio that corresponds to the television program or channel is communicated to the mobile phone to render as a telephone communication at block 316.

FIG. 4 illustrates example method(s) 400 of television audio via phone, and is described with reference to a mobile phone. The order in which the method is described is not intended to be construed as a limitation, and any number of the described method blocks can be combined in any order to implement the method, or an alternate method.

At block 402, a request for a television program or channel is initiated. For example, mobile phone 128 (FIG. 1) initiates a request for a television program or channel as a telephone call or as a text message. The telephone call can include menu selections, such as keypad inputs or voice-prompted inputs, to identify the television program or television channel that is being requested. The mobile phone 128 can initiate the request for the television program or channel with the telephone exchange service 126 at content distributor 102.

At block 404, television audio that corresponds to the television program or channel is received as a telephone communication. For example, mobile phone 128 receives television audio that corresponds to the requested television program or channel as a telephone communication (e.g., telephone call). A user of the mobile phone can then listen to the television audio feed as a regular telephone communication, or telephone call.

FIG. 5 illustrates various components of an example service 500 that can implemented as television audio service 142 and/or television audio service 202 to implement various embodiments of television audio via phone, such as shown in respective FIGS. 1 and 2. Service 500 can include one or more communication interfaces 502 that can be implemented as any one or more of a serial and/or parallel interface, a wireless interface, any type of network interface, a modem, and as any other type of communication interface for data and/or voice communication. The communication interfaces 502 provide a connection and/or communication links between service 500 and communication network(s) by which other communication, electronic, and computing devices can communicate with service 500.

Service 500 can include one or more processors 504 (e.g., any of microprocessors, controllers, and the like) which process various computer-executable instructions to control the operation of service 500 and to implement embodiments of television audio via phone. Alternatively or in addition, service 500 can be implemented with any one or combination of hardware, firmware, or fixed logic circuitry that is implemented in connection with signal processing and control circuits generally identified at 506.

Service 500 can also include computer-readable media 508, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 508 provides data storage mechanisms to store various types of information and/or data related to operational aspects of service 500, such as customer information 510, and provides storage for various service applications 512. For example, an operating system 514 can be maintained as a computer application with the computer-readable media 508 and executed on the processors 504. The service applications 512 can also include a telephone exchange service 516. In this example, the service applications 512 are shown as software modules and/or computer applications that can implement various embodiments of television audio via phone.

Although not shown, service 500 can include a system bus or data transfer system that couples the various components within the service. A system bus can include any one or combination of different bus structures, such as a memory bus or memory controller, a peripheral bus, a universal serial bus, and/or a processor or local bus that utilizes any of a variety of bus architectures.

FIG. 6 illustrates various components of an example device 600 that can be implemented as any form of a mobile communication, computing, electronic, and/or media device to implement various embodiments of television audio via phone. For example, device 600 can be implemented as a mobile phone, computer device, television client device, or content distributor as shown in FIG. 1 and/or FIG. 2. In various embodiments, device 600 can be implemented as any one or combination of a wireless or mobile phone, a portable computer device, and/or as any other type of mobile device that may be implemented for data and/or voice communication.

Device 600 can include customer and/or user data 602, such as information associated with an owner and user of the device, or customer registration information. Device 600 further includes one or more communication interfaces 604 that can be implemented for any type of data and/or voice communication via communication network(s).

Device 600 can include one or more processors 606 (e.g., any of microprocessors, controllers, and the like) which process various computer-executable instructions to control the operation of device 600 and to implement embodiments of television audio via phone. Alternatively or in addition, device 600 can be implemented with any one or combination of hardware, firmware, or fixed logic circuitry that is implemented in connection with signal processing and control circuits which are generally identified at 608.

Device 600 can also include computer-readable media 610, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 610 provides data storage mechanisms to store the customer and/or user data 602, as well as various device applications 612 and any other types of information and/or data related to operational aspects of device 600. For example, an operating system 614 can be maintained as a computer application with the computer-readable media 610 and executed on the processors 608. The device applications 612 can also include a device manager 616 and a television audio service 618. In this example, the device applications 612 are shown as software modules and/or computer applications that can implement various embodiments of television audio via phone.

Device 600 can also include an audio, video, and/or image processing system 620 that provides audio data to an audio rendering system 622 and/or provides video or image data to a display system 624. The audio rendering system 622 and/or the display system 624 can include any devices or components that process, display, and/or otherwise render audio, video, and image data. The audio rendering system 622 and/or the display system 624 can be implemented as integrated components of the example device 600.

Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of television audio via phone have been described in language specific to features and/or methods, it is to be understood that the subject of the appended claims is not necessarily limited to the specific features or methods described. Rather, the specific features and methods are disclosed as example implementations of television audio via phone.

1. A method, comprising:
receiving a request for a television program from a mobile phone;
accessing a video feed of the television program to obtain television audio that corresponds to the television program; and
communicating the television audio to the mobile phone to render as a telephone communication.

2. A method as recited in claim 1, wherein the request for the television program is received as a telephone call initiated from the mobile phone.

3. A method as recited in claim 2, wherein the telephone call initiated from the mobile phone includes one or more menu selections to identify the television program.

4. A method as recited in claim 3, wherein the one or more menu selections include at least one of keypad inputs or voice-prompted inputs to identify the television program.

5. A method as recited in claim 1, wherein the request for the television program is received as a text message initiated from the mobile phone.

6. A method as recited in claim 5, further comprising:
parsing the text message to determine the television program; and
initiating a telephone call to the mobile phone to communicate the television audio that corresponds to the television program to the mobile phone.

7. A method as recited in claim 1, further comprising determining that the mobile phone is registered to a user that has a corresponding television client device configured to receive and render the television program for viewing.

8. A content distributor, comprising:
a television audio service configured to access a video feed of a television program to obtain television audio that corresponds to the television program; and
a telephone exchange service configured to communicate the television audio via a mobile communications network to a mobile phone to render as a telephone communication.

9. A content distributor as recited in claim 8, wherein the telephone exchange service is further configured to receive a request for a television channel that carries the television program as a telephone call initiated from the mobile phone.

10. A content distributor as recited in claim 8, wherein the telephone exchange service is further configured to receive a request for the television program as a telephone call initiated from the mobile phone.

11. A content distributor as recited in claim 10, wherein the telephone exchange service is further configured to receive the telephone call as one or more menu selections that identify the television program.

12. A content distributor as recited in claim 11, wherein the telephone exchange service is further configured to receive the one or more menu selections as at least one of keypad inputs or voice-prompted inputs to identify the television program.

13. A content distributor as recited in claim 8, wherein the telephone exchange service is further configured to receive a request for the television program as a text message initiated from the mobile phone.

14. A content distributor as recited in claim 13, wherein the television audio service is further configured to parse the text message to determine the television program, and wherein the telephone exchange service is further configured to initiate a telephone call to the mobile phone to communicate the television audio that corresponds to the television program to the mobile phone.

15. A content distributor as recited in claim 8, wherein the television audio service is further configured to determine that the mobile phone is registered to a user that has a corresponding television client device configured to receive and render the television program for viewing.

16. A mobile phone, comprising:
a communication interface configured for communication with a telephone exchange service via a mobile communications network; and
communication logic configured to initiate a request via the communication interface for a television program, and receive television audio that corresponds to the television program as a telephone communication.

17. A mobile phone as recited in claim 16, wherein the communication logic is further configured to initiate the request for the television program as a telephone call.

18. A mobile phone as recited in claim 17, wherein the communication logic is further configured to communicate the telephone call as one or more menu selections that identify the television program.

19. A mobile phone as recited in claim 16, wherein the communication logic is further configured to initiate the request for the television program as a text message.

20. A mobile phone as recited in claim 16, wherein the communication logic is further configured to receive the telephone communication as an incoming call that includes the television audio.
